(19) United States
(12) Patent Application Publication
(10) Pub. No.: US 2004/0167807 A1
(43) Pub. Date: Aug. 26, 2004

(54) System and method for securitizing life insurance contracts

(75) Inventors: Peter Joseph Fitzsimmons, Fairfax, VA (US); Edward Willis Perry, Glenwood, MD (US)

Correspondence Address: PATTON BOGGS, 1660 LINCOLN ST, SUITE 2050, DENVER, CO, 80264, US

(73) Assignee: Partnership for community Development, LLC

(21) Appl. No.: 10/368,400

(22) Filed: Feb. 20, 2003

(51) Int. Cl. G06F 17/60

(52) U.S. Cl. 705/4

(57) ABSTRACT

A system and method of the invention uses an inventive contract structure to fund credit enhancements for borrowers and other community development activities. The system includes at least one collection component and a processing company. The collection component obtains insurance policy information from eligible borrowers. The processing company creates a special purpose vehicle for holding a plurality of life insurance contracts, where each of the plurality of life insurance contracts is based on the insurance policy information from at least one eligible borrower. The plurality of life insurance contracts serve as collateral for a plurality of financial instruments created by the special purpose vehicle. The special purpose vehicle also uses a residual value from the life insurance contracts to pay, for example, the premiums required by the life insurance contracts and as collateral for the plurality of the financial instruments. The system also includes means for transmitting the insurance policy information from the at least one collection component to the processing company and for using the special purpose vehicle to fund liquidity needs that are associated with the inventive system.

### FIELD OF THE INVENTION

The present invention relates to a system and method for securitizing life insurance contracts, and more particularly, relates to a system and method for generating funding using life insurance contracts and financial instruments in accordance with the principles of the invention.

### BACKGROUND OF THE INVENTION

Many financial institutions that accept deposits and that are federally insured, such as thrifts, banks, and credit unions, are required to regularly report detailed financial information to a variety of federal and state regulatory agencies. This detailed financial information includes, for example, information on borrowers who access services provided by these financial institutions. Based on the detailed financial information, it has been determined that barriers exist prohibiting certain types of borrowers from accessing services provided by these financial institutions. For example, certain borrowers may be prevented from obtaining loans offered by these institutions because of a lack of qualifying income. Moreover, even with qualifying income, low to moderate income borrowers are typically associated with higher delinquency rates. As such, these borrowers may be denied access to services even when they qualify for those services. Nevertheless, these borrowers have financial needs that must be met.

In an effort to overcome these problems and incent financial institutions to offer greater access to services, the United States Congress enacted laws that require depository institutions to meet certain needs of the communities in which they operate. Financial institutions can meet these needs, for example, by funding credit enhancements for eligible borrowers and/or other community development activities. In particular, the Community Reinvestment Act of 1977, enacted by Congress, requires depository institutions to help meet the credit needs of certain low to moderate income borrowers. Pursuant to the Community Reinvestment Act, depository financial institutions are obligated to expand their markets through new services and products, and to provide financial services to eligible borrowers in designated census tracts within their geographic footprint or region. Despite the requirements of the Community Reinvestment Act, the needs of certain marketplaces, such as marketplaces with low to moderate income borrowers, are typically not fulfilled. For example, low to moderate income borrowers that are covered by the Community Reinvestment Act often cannot purchase homes because of the lack of qualifying income, lack of a stable income, and/or the lack of funds for down payment on the loan.

Fannie Mae™ Corporation has attempted to provide one solution to this problem by enabling a borrower to purchase a financial insurance against a mortgage loan. The financial insurance is built into the mortgage loan and it enables the borrower to skip mortgage payments for a predefined amount of time during a financial difficulty. Borrowers are also allowed to purchase a home warranty loan that covers repair or replacement of major mechanical systems on a property being purchased. This prevents the borrower from incurring an unexpected financial expense when a major mechanical system breaks down. In addition to obtaining a mortgage loan, however, borrowers must pay for the financial insurance and home warranty loan to access these services. For a low to moderate income borrower that barely qualifies for the mortgage loan, these additional services are typically unaffordable.

Fannie Mae™ has proposed offering to mortgage borrowers, through participating lending institutions, the opportunity to obtain life insurance that guarantees full payment of the mortgage in the event of the death of the borrower. Prior to closing on a mortgage loan, the borrower executes a consent form that is forwarded by the participating lending institution to an administrative entity created by Fannie Mae™. The administrative entity underwrites and pays premiums associated with the life insurance. But, the borrower pays yearly federal taxes on the imputed income represented by premiums paid by the administrative entity. As a quasi-federal agency, Fannie Mae™ has the ability to borrow money for the insurance premiums at preferential rates in capital markets and receive an annual interest yield on the life insurance premiums from participating life insurance companies. Prior to providing this service, Fannie Mae™ must obtain approval from federal regulators; and it must be shown that designing and financing credit life insurance is within the corporation's congressional charter. To date, it is believed that Fannie Mae™ has not implemented this service.

Innovative financial products and structures are still needed to increase the availability and affordability of finance, especially, for low to moderate income borrowers and small business owners. Moreover, what is needed is a structure that is financial viable and attractive to investors and companies without access to the advantages that are available to federal agencies.

### SUMMARY OF THE INVENTION

The present invention relates to a system for generating funding, including, at least one of a number of credit enhancements for predefined borrowers and other community development activities including borrower education and real estate rehabilitation. The system includes at least one collection component and a processing company. The collection component obtains insurance policy information from the predefined borrowers. The processing company creates a special purpose vehicle for holding a plurality of life insurance contracts, where each of the plurality of life insurance contracts is based on the insurance policy information from at least one predefined borrower. The plurality of life insurance contracts serve as collateral for a plurality of financial instruments stored in the special purpose vehicle. The special purpose vehicle uses residual value from the life insurance contracts to pay, for example, the premiums required by the plurality life insurance contracts and as collateral for the plurality of the financial instruments. The system also includes means for transmitting the insurance policy information from at least one collection component to the processing company and for using the special purpose vehicle to fund liquidity needs that are associated with the inventive system.

The inventive system funds credit enhancements for predefined borrowers and other community development activities by: obtaining insurance policy information from a plurality of predefined borrowers; purchasing life insurance contracts against each of the plurality of predefined borrowers; creating a special purpose vehicle for holding the pool of life insurance contracts; paying, by the special purpose vehicle, a premium associated with each of the life insurance contracts; upon a death of each of the plurality of predefined borrowers, using a residual death benefit from the life insurance contract to fund at least one of the financial instruments in the special purpose vehicle and expenses; and using the special purpose vehicle to fund at least one of credit enhancements and community development activities by making payments to a recipient. The inventive system therefore improves the delinquency performance of mortgage loans under the Community Reinvestment Act and mitigates certain losses that may be incurred by lenders to borrowers in certain demographic groups through the credit enhancements.

Additional features and advantages of the invention will be set forth in the description that follows, and in part will be apparent from the description, or may be learned by practice of the invention. The objectives and advantages of the invention will be realized and attained by the system and method particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention.

In the drawings:

FIG. 1 illustrates a local area network (LAN) 100 that enables participants to fund credit enhancements for eligible borrowers and community development activities in accordance with the principles of the invention;

FIG. 2 illustrates participants on LAN 100 that fund credit enhancements for eligible borrowers and community development activities in accordance with the principles of the invention; and

FIG. 3 illustrates a preferred embodiment of the steps implemented in carrying out the inventive system.

### DESCRIPTION OF PREFERRED EMBODIMENTS

Reference will now be made in detail to the preferred embodiments of the present invention, examples of which are illustrated in the accompanying drawings. The present invention described below extends the functionality of the inventive system and method for using residual values from life insurance contracts in accordance with the principles of the invention to provide funding for credit enhancements for eligible borrowers and community development activities.

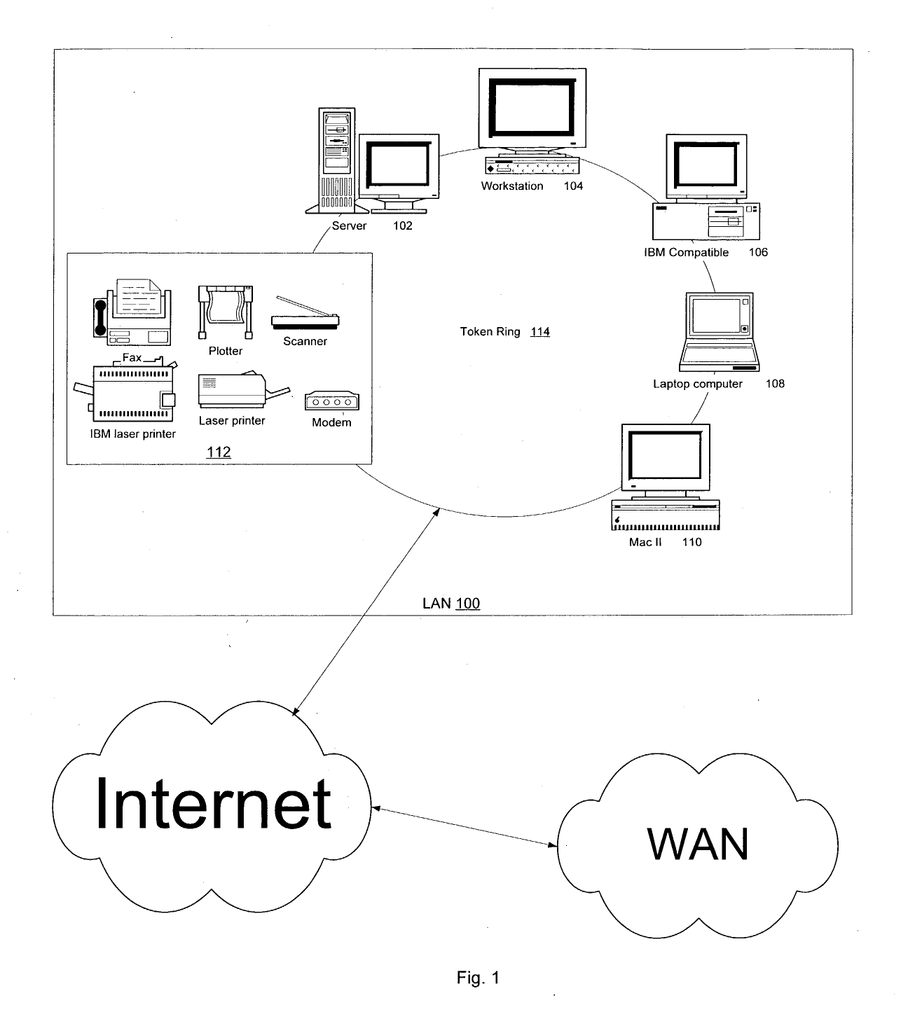

FIG. 1 illustrates a local area network (LAN) 100 that enables funding credit enhancements and other community development activities. LAN 100 comprises a server 102, four computer system 104, 106, 108 and 110, and peripherals, such as printers and other devices 112, that may be shared by components on LAN 100. Computer systems 104, 106, 108 and 110 may serve as clients for server 102 and/or as clients and/or servers for each other and/or for other components connected to LAN 100. Components on LAN 100 are preferably connected together by cable media, for example, copper or fiber-optic cable and the network topology may be a token ring topology 114. It should be apparent to those of ordinary skill in the art that other media, for example, wireless media, such as optical and radio frequency, may also connect LAN 100 components. It should also be apparent that other network topologies, such as Ethernet, may be used.

According to the invention, LAN 100 is connected to the Internet and may be connected to other LANs or Wide Area Networks (WAN). Hence some components of LAN 100 are preferably Web-enabled. The computer processors used to execute the inventive system and method, for example server 102 and/or computer system 104, 106, 108 and 110, include electronic storage media, such as disks, for storing programming code and data structures used to implement the inventive method and outputs therefrom. The invention uses computer system 104, 106, 108 and 110 to implement the invention described herein. Note, however, that any computer system may be configured to implement the inventive method and computer system 104, 106, 108 and 110 are only used for exemplary purposes.

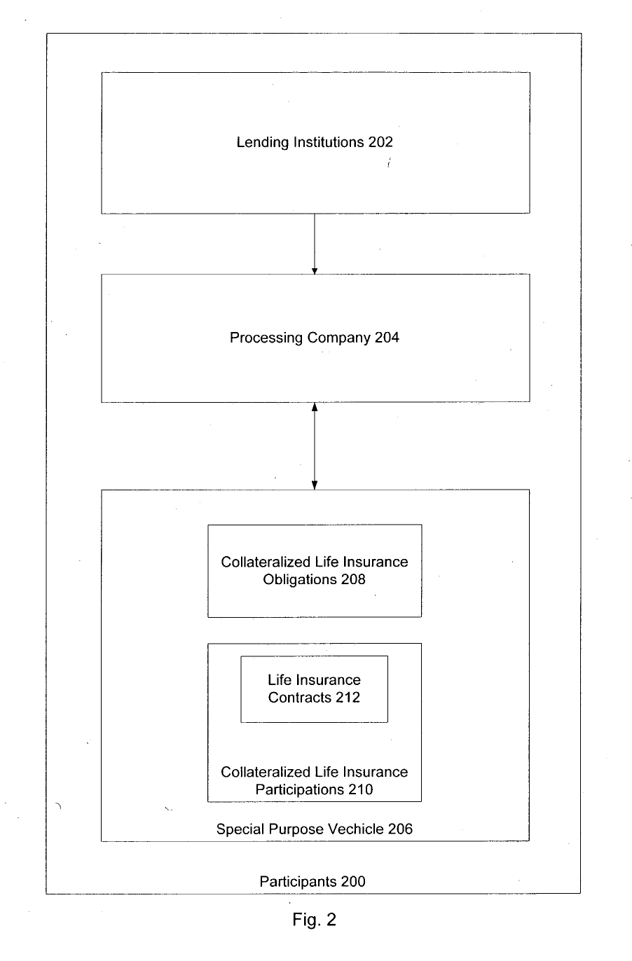

FIG. 2 illustrates participants 200 on LAN 100 that provide funding for credit enhancements and community development activities in accordance with a preferred embodiment of the invention. As shown, and discussed in more detail below, participants 200 include multiple lending institutions 202, a processing company 204, and a special purpose vehicle 206 that includes financial instruments, such as Community Life Insurance Obligations 208 and Community Life Insurance Participations 210.

Lending institutions 202 can include any type of financial institution, for example, a bank, or a credit union. Any type of lending is contemplated in accordance with the invention, including, preferably, mortgage lending. According to the invention, when a predefined borrower, for example a low to moderate income borrower, obtains a loan from lending institution 202, the borrower is offered the opportunity to execute an insurance application, an information release form releasing lending institution 202 and its affiliates from certain liabilities, and a consent and disclosure letter explaining the terms of the underlying life insurance contract. This allows processing company 204 to purchase a life insurance policy on the borrower's life. In accordance with the principles of the invention, the insurance is offered at no expense to the borrower. Thereafter, life insurance contract is purchased on the borrower. After a predefined time, for example ninety days after the borrower executes the application for insurance, the insurance commitment becomes effective. The life insurance contracts can be modified or non-modified endowment contracts and may either be variable, universal or whole life insurance products.

Processing company 204 aggregates a predefined number of policies to form a pool of life insurance contracts 212 and creates a life insurance contract structure referred to as special purpose vehicle 206, where the underlying life insurance contracts serve as collateral for financial instruments 208 and 210. Special purpose vehicle 206 can be a partnership, a limited liability company, a trust or a combination of legal entities. The purpose of the special purpose vehicle 206 is to hold the life insurance contracts and financial instruments, specifically, Community Life Insurance Obligations 208 and Community Life Insurance Participations 210. Processing company 204 uses a combination of financial instruments, namely, Community Life Insurance Obligations 208 and Community Life Insurance Participations 210, throughout the life cycle of the pool of life insurance contracts 212 to generate funding.

Thus, according to a preferred embodiment of the invention, one of the financial instruments in special purpose vehicle 206 is Community Life Insurance Obligations 208. Community Life Insurance Obligations 208 may be rated debt obligations, typically term and bullet loans with a fixed rate of interest based on a spread to other comparable financial instruments in a given market. Community Life Insurance Obligations 208 may be of the type that matures in two to fifteen years. Ratings for Community Life Insurance Obligations 208 may be obtained to achieve better execution for the debt in a given market.

Another financial instrument in special purpose vehicle 206 is Community Life Insurance Participations 210. Community Life Insurance Participations 210 are preferably equity interests in special purpose vehicle 206 which own the pool of life insurance contracts 212. Community Life Insurance Participations 210 preferably mature in twenty to thirty years. In another embodiment, Community Life Insurance Participations 210 have no specific maturity or duration. Community Life Insurance Participations 210 benefit from receiving the life insurance death benefit residuals on a tax-free basis.

In a preferred embodiment of the invention, Community Life Insurance Obligations 208 holders will not be able to syndicate their debt obligations and Community Life Insurance Participation 210 holders will not be able to transfer their equity without written permission from processing company 204.

Community Life Insurance Obligations 208 and Community Life Insurance Participations 210 can be initially funded on private placement bases. In exchange, these investors participate in certain income generated by special purpose vehicle 206. Alternatively, investors may fund special purpose vehicle 206 on a periodic basis, for example, during the life cycle of the pool of life insurance contracts 212 in special purpose vehicle 206. As is apparent to one skilled in the art, Community Life Insurance Obligations 208 and Community Life Insurance Participations 210 may also be delivered to public debt and capital markets. Regardless, special purpose vehicle 206 pays premiums required by the life insurance contracts 212 and can do so as a single premium or on an installment basis over a predefined period, for example no less than seven years. After the cost of the insurance on the borrower is paid and period changes are accounted for, the insurance company issuing the policies will invest the premiums in cash value separate accounts. As the value of these cash value separate accounts increase over time, the cash value separate account can be used as primary collateral for the financial instruments 208 and 210.

In one example of the invention, upon the death of the insured borrower, a percentage of the death benefits under the life insurance contract can be designated to the borrower's beneficiaries. The inventive system therefore enables insured borrowers to build long term assets that provide a legacy for the borrower's beneficiaries. Special purpose vehicle 206 receives the gross death benefit residuals.

Funds generated in special purpose vehicle 206 in accordance with the principles of the invention are used to fund the operating, debt, and capital requirements of the vehicle 206. Processing company 204 also uses some funds generated by special purpose vehicle 206 to fund community development activities and credit enhancements, for example, based on a set schedule of required payments established during inception of special purpose vehicle 206. Processing company 204 may make the payments to an affiliated company, an independent community development organization, or a third party designated to facilitate a specific purpose under identified community activities.

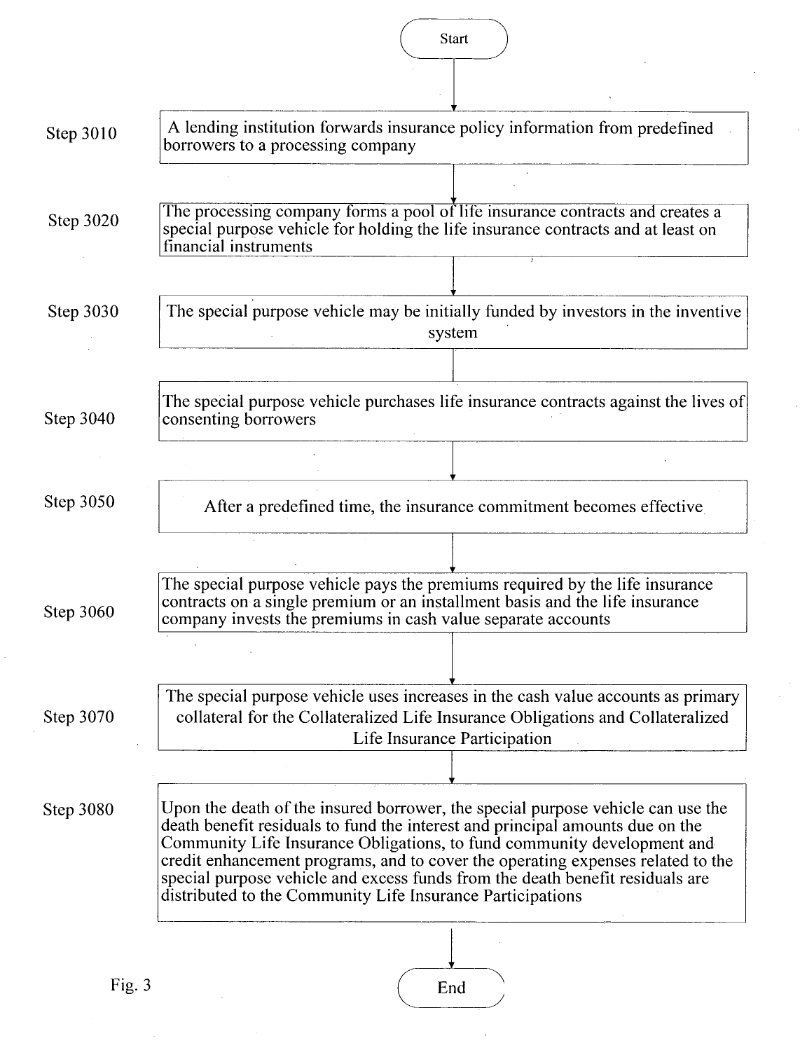

Referring now to FIG. 3, the steps implemented in a preferred embodiment of the inventive system and method are discussed. In Step 3010, lending institution 202 forwards insurance policy information from predefined borrowers to processing company 204. In Step 3020, processing company 204 forms a pool of life insurance contracts 212 and creates special purpose vehicle 206 for holding life insurance contracts 212 and financial instruments 208 and 210. In Step 3030, investors may initially fund special purpose vehicle 206. In Step 3040, special purpose vehicle 206 purchases life insurance contracts against the lives of consenting borrowers. In Step 3050, after a predefined time, the insurance commitment becomes effective. In Step 3060, special purpose vehicle 206 pays the premiums required by the life insurance contracts on a single premium or an installment basis over a predefined period and the life insurance company invests the premiums in cash value separate accounts. In Step 3070, special purpose vehicle 206 uses increases in the cash value separate accounts of the life insurance contracts as primary collateral for Community Life Insurance Obligations 208 and Community Life Insurance Participation 210.

In Step 3080, upon the death of the insured borrower, special purpose vehicle 206 can use the death benefit residuals to fund the interest and principal amounts due on Community Life Insurance Obligations 208, to fund community development and credit enhancement programs, and to cover the operating expenses related to the special purpose vehicle. Excess funds from the death benefit residuals are distributed to the Community Life Insurance Participations 210.

The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed:

1. A system for funding credit enhancements for predefined borrowers and community development activities, the system comprises:
at least one collection component that obtains insurance policy information from the predefined borrowers;
a processing company that creates a special purpose vehicle for holding a plurality of life insurance contracts, wherein each of the plurality of life insurance contracts is based on the insurance policy information from at least one predefined borrower, and that creates a plurality of financial instruments, wherein the plurality of life insurance contracts serve as collateral for a plurality of financial instruments and the processing company uses a combination of financial instruments to generate funding for at least one of expenses, credit enhancements and community development activities;
means for transmitting the insurance policy information from the at least one collection component to the processing company, for using residual death benefits from the plurality of life insurance contracts to fund at least one financial instrument in the special purpose vehicle and to fund other liquidation needs associated with the special purpose vehicle; and
means for transmitting funding from the special purpose vehicle to a recipient for at least one of expenses, credit enhancements, and community development activities by making payments to the recipient.

2. The system of claim 1, wherein the at least one collection component is at least one financial institution.

3. The system of claim 1, wherein the predefined borrowers are low to moderate income borrowers.

4. The system of claim 1, wherein when a predefined borrower obtains a loan from at least one collection component, the predefined borrower is offered an opportunity to execute an insurance application and obtain life insurance at no expense.

5. The system of claim 1, wherein the each of the plurality of life insurance contracts is at least one of variable, universal and whole life insurance products.

6. The system of claim 1, wherein the processing company creates the special purpose vehicle after the processing company aggregates a predefined number of life insurance contracts.

7. The system of claim 1, wherein the plurality of financial instruments include rated debt obligations and equity interests, wherein the equity interests receive residual death benefits from the life insurance contracts.

8. The system of claim 7, wherein the rated debt obligations are term and bullet loans with a fixed rate of interest that is based on a spread to other comparable financial instruments in a given market.

9. The system of claim 7, wherein the rated debt obligations mature in two to fifteen years.

10. The system of claim 7, wherein ratings for the rated debt obligations are obtained to achieve a better execution for the debt in a given market.

11. The system of claim 7, wherein the equity interests mature in twenty to thirty years.

12. The system of claim 7, wherein the rated debt obligations and the equity interests are initially funded on a private placement basis and investors participate in certain income generated by the special purpose vehicle.

13. The system of claim 7, wherein the rated debt obligations and the equity interests are funded on a periodic basis.

14. The system of claim 7, wherein funding for the rated debt obligations and the equity interests is used to pay premiums associated with the plurality of life insurance contracts and an insurance company issuing the policy for each of the plurality of life insurance contracts invests a predefined portion of the premium in a cash value separate account, wherein increases in the value of the cash value separate account is used as primary collateral for the plurality of financial instruments.

15 The system of claim 7, wherein the rated debt obligations and the equity interests are delivered to public financial markets.

16. The system of claim 1, wherein the special purpose vehicle is funded at creation and the funds are used for operating, debt and capital requirements of the special purpose vehicle.

17. The system of claim 1, wherein the processing company funds credit enhancements and community developments with required payments that are established during inception of the special purpose vehicle.

18. The system of claim 1, wherein the processing company uses a residual value from a life insurance contract to pay the premiums required by other life insurance contracts in the special purpose vehicle and as collateral for the plurality of financial instruments.

19. The system of claim 1, wherein the special purpose vehicle is a legal entity.

20. A method for funding credit enhancements for predefined borrowers and community development activities, the method comprises the steps of:
obtaining insurance policy information from a plurality of predefined borrowers;
purchasing life insurance contracts against each of the plurality of predefined borrowers;
creating a special purpose vehicle for holding a pool of life insurance contracts;
using the pool of life insurance contracts as collateral for at least one financial instrument;
paying, by the special purpose vehicle, a premium associated with each of the life insurance contracts;
upon a death of each of the plurality of eligible borrowers, using a residual death benefit from the life insurance contract to fund at least one of the financial instruments in the special purpose vehicle and expenses; and
using the special purpose vehicle to fund at least one of credit enhancements and community development activities by making payments to a recipient.

21. The method of claim 20, further comprising the step of initially funding at least one financial instrument on a private placement basis.

22. The method of claim 20, further comprising the step of funding at least one financial instrument on a public debt market.

23. The method of claim 20, further comprising the step of initially funding the special purpose vehicle when it is created, wherein the funds are used to fund operating debt, and capital requirements of the special purpose vehicle.

24. A computer-readable medium whose contents cause a computer system to fund credit enhancements for predefined borrowers and community development activities, by performing the steps of:
purchasing life contacts against each of the plurality of predefined borrowers;
creating a special purpose vehicle for holding a pool of life insurance contracts;
using the pool of life insurance contracts as collateral for at least one financial instrument;
paying, by the special purpose vehicle, a premium associated with each of the life insurance contracts;
upon a death of each of the plurality of predefined borrowers, using a residual death benefit from the life insurance contract to fund at least one of the financial instruments in the special purpose vehicle and expenses; and
using the special purpose vehicle to fund at least one of credit enhancements and community development activities by making payments to a recipient.
